(19) United States
(12) Patent Application Publication
(10) Pub. No.: US 2011/0216687 A1
(43) Pub. Date: Sep. 8, 2011

(54) Method and Apparatus for Accounting Multicast Broadcast Service

(75) Inventors: Wei Zhang, Shanghai (CN); Liang Gu, Chengdu (CN); Limei Wang, San Diego, CA (US)

(73) Assignee: HUAWEI TECHNOLOGIES CO., LTD., Shenzhen (CN)

(21) Appl. No.: 13/101,523

(22) Filed: May 5, 2011

Related U.S. Application Data
(63) Continuation of application No. PCT/CN2009/074803, filed on Nov. 5, 2009.

(30) Foreign Application Priority Data
Nov. 5, 2008 (CN) 200810217255.8

(51) Int. Cl. H04W 4/06

(52) U.S. Cl. 370/312

(57) ABSTRACT

In a method for accounting a multicast broadcast service (MBS), an Access Service Network (ASN) receives MBS service accounting information sent by an MBS accounting agent. The MBS service accounting information includes an MBS service identifier and MBS service granularity-based accounting information. A mobile station (MS) is determined using the MBS service according to the MBS service identifier. Subscriber service granularity-based accounting information of the MS is generated and the generated accounting information is sent to an accounting system.

This application is a continuation of International Application No. PCT/CN2009/074803, filed on Nov. 5, 2009, which claims priority to Chinese Patent Application No. 200810217255.8, filed on Nov. 5, 2008, both of which are hereby incorporated by reference in their entireties.

### FIELD OF THE DISCLOSURE

The present disclosure relates to the technical field of communications, and more particularly to a method and an apparatus for accounting a multicast broadcast service.

### BACKGROUND OF THE DISCLOSURE

Worldwide Interoperability for Microwave Access (WiMAX) is a wireless metropolitan area networking technology based on IEEE802.16 Standard. A WiMAX network wireless side is a wireless metropolitan area networking access technology based on IEEE802.16d/e Standard, and can be effectively anti-multipath fading by adopting physical layer technologies of Orthogonal Frequency Division Multiplexing (OFDM) and Orthogonal Frequency Division Multiplexing Access (OFDMA). Under the circumstance of the best channel fading, the transmission rate may approach 75 Mbps.

A WiMAX network logical architecture is shown in FIG. 1, in which the entire WiMAX network mainly consists of the following three parts:

(1) a terminal, including a subscriber station (SS) or mobile station (MS), and used by a subscriber to access the WiMAX network.

(2) an Access Service Network (ASN), which is defined as a set of network functions providing wireless access service to a WiMAX terminal. An ASN includes a base station (BS) network element and an ASN Gateway (ASN-GW) network element, wherein the BS network element provides L2 connectivity between a BS and an MS and wireless resource management and other functions; and the ASN-GW network element mainly functions to provide a client function for MS authentication, authorization and accounting functions, and provide a Relay function of L3 information (such as IP address assignment), and intra-ASN handover; and

(3) a Connectivity Service Network (CSN), which is configured to provide an IP connectivity service for a WiMAX terminal. A CSN mainly includes logical entities such as a prepaid server, an Authentication, Authorization, and Accounting (AAA) server, and mainly provides the functions of IP address assignment for an MS, Internet access, AAA proxy or server, authorization control per terminal.

Communications as mentioned conventionally refers to communications between one node and another node. However, with increase of subscriber requirements and introduction of multimedia, subscribers need one-to-multiple communications or multiple-to-multiple communications, thereby leading to arising of Point-to-Multipoint (PTM) transmission modes. To support the modes on a mobile network, realize one-to-multiple multicast broadcast services and make effective use of mobile network resources, multicast broadcast service (MBS) is defined based on the WiMAX in the prior art. The MBS service is a point-to-multipoint service of providing a data source in the mobile network and sending data to a plurality of subscribers, so as to realize network resource sharing and increase the utilization rate of network resources, particularly air interface resources. The MBS defined on the basis of the WiMAX can realize not only message-type multicast and broadcast in plain text and with a low rate, but also multicast broadcast of high-speed multimedia service, which undoubtedly follows the trend of mobile data development in the future.

The MBS service based on a WiMAX network supports two access modes: single base station access and multi-base station access. In multi-base station access mode, an MBS zone, which is identified by MBS_zone ID, is defined as a set of a plurality of base stations. All the base stations in an MBS zone send the content of a same MBS service flow by using a same Multicast CID and MBS Group Security Association (MBS GSA). A terminal which has registered the MBS service may receive MBS service data through a plurality of base stations in the MBS zone; and when a terminal in an idle state moves across the base stations in the MBS zone, the terminal does not need to reestablish connectivity and may receive the MBS service without being affected, which realizes seamless handover of the MBS service. The MBS in single base station mode is a specific example of the MBS in multi-base stations access mode. The range of the MBS zone is limited to be within the range covered by a base station, and all the subscribers receiving the MBS in an MBS zone use the same multicast connectivity identifier.

At present, it is not defined how to account the MBS service in the WiMAX network in the prior art. If the existing method for accounting a unicast service is used to account the multicast service, a large amount of data shall be transmitted, which has a great impact on the ASN network and affects the performance of the entire network.

### SUMMARY OF THE DISCLOSURE

Embodiments of the present disclosure provide a method and an apparatus for accounting a multicast broadcast service to account an MBS service.

The technical solutions of the embodiments of the present disclosure will be described as follows.

In one embodiment method for accounting a multicast broadcast service an ASN receives MBS service accounting information sent by an MBS accounting agent. The MBS service accounting information includes an MBS service identifier and MBS service granularity-based accounting information. An MS that uses the MBS service is determined according to the MBS service identifier. Subscriber service granularity-based accounting information of the MS is generated the generated accounting information is sent to an accounting system.

In another embodiment method for accounting a multicast broadcast service, an Anchor Service Flow Authentication (Anchor SFA) in an ASN detects an occurrence of a trigger event of providing an MBS service to an MS and sends an MBS request to an MBS Proxy. An accounting client in the ASN receives first current MBS service granularity-based accounting information collected by an MBS accounting agent located together with the MBS Proxy. The Anchor SFA in the ASN detects an occurrence of a trigger event that the MS exits the MBS service and sends a request for terminating the MBS service to the MBS Proxy. The accounting client in the ASN receives second current MBS service granularity-based accounting information collected by the MBS accounting agent located together with the MBS Proxy. Subscriber service granularity-based accounting information actually used by the MS is generated according to the first current MBS service granularity-based accounting information and the second current MBS service granularity-based accounting information. The generated accounting information is reported to an accounting system.

In another embodiment method for accounting a multicast broadcast service, an Anchor SFA in an ASN detects an occurrence of a trigger event of providing an MBS service to an MS and sends an MBS request to an MBS Proxy. An accounting client in the ASN receives first current MBS service granularity-based accounting information collected by an MBS accounting agent located together with the MBS Proxy, converts the first current MBS service granularity-based accounting information to subscriber service granularity-based accounting information of the MS, and reports the converted accounting information to an accounting system. The Anchor SFA in the ASN detects an occurrence of a trigger event that the MS exits the MBS service and sends a request for terminating the MBS service to the MBS Proxy. The accounting client in the ASN receives second current MBS service granularity-based accounting information collected by the MBS accounting agent located together with the MBS Proxy, converts the second current MBS service granularity-based accounting information to subscriber service granularity-based accounting information, and reports the converted accounting information to the accounting system.

An apparatus for accounting a multicast broadcast service includes a receiving module that is configured to receive an MBS service identifier and MBS service granularity-based accounting information sent by an MBS accounting agent. An authenticator is configured to search for MS contexts maintained locally according to the MBS service identifier, and to find MSs currently using the MBS service. An accounting client is configured to add identification information of each of the MSs to the respective MBS service granularity-based accounting information, to generate subscriber service granularity-based accounting information of each of the MSs, and to send the generated accounting information to an accounting system.

An MBS accounting agent includes a collecting module that is configured to collect current MBS service accounting information based on service granularity, where the MBS service accounting information includes an MBS service identifier and MBS service granularity-based accounting information. A sending module is configured to send the MBS service accounting information to an ASN.

An MBS gateway includes the above MBS accounting agent and further includes an MBS Proxy, which is configured to receive an MBS request or a request for terminating an MBS service sent by an Anchor SFA, to trigger the MBS accounting agent to collect MBS accounting information based on service granularity, and to send the collected accounting information to the ASN.

An apparatus for accounting a multicast broadcast service includes an Anchor SFA that is configured to detect occurrence of a trigger event of providing an MBS service to an MS and to send an MBS request to an MBS Proxy. An accounting client is configured to receive first current MBS service granularity-based accounting information collected by an MBS accounting agent located together with the MBS Proxy. The Anchor SFA is further configured to detect occurrence of a trigger event that the MS exits the MBS service and to send a request for terminating the MBS service to the MBS Proxy. The accounting client is further configured to receive second current MBS service granularity-based accounting information collected by the MBS accounting agent located together with the MBS Proxy. The accounting client is further configured to generate subscriber service granularity-based accounting information actually used by the MS according to the first current MBS service granularity-based accounting information the second current MBS service granularity-based accounting information, and to report the generated accounting information to the accounting system.

An apparatus for accounting a multicast broadcast service includes an Anchor SFA that is configured to detect occurrence of a trigger event of providing an MBS service to an MS and to send an MBS request to an MBS Proxy. An accounting client is configured to receive first current MBS service granularity-based accounting information collected by an MBS accounting agent located together with the MBS Proxy, to generate subscriber service granularity-based accounting information, and to report the generated accounting information to an accounting system. The Anchor SFA is further configured to detect occurrence of a trigger event that the MS exits the MBS service and to send a request for terminating the MBS service to the MBS Proxy. The accounting client is further configured to receive second current MBS service granularity-based accounting information collected by the MBS accounting agent located together with the MBS Proxy, to generate subscriber service granularity-based accounting information, and to report the generated accounting information to the accounting system.

The method and the apparatus for accounting a multicast broadcast service according to the embodiments of the disclosure implements accounting on the MBS service, and due to the adoption of the service granularity-based accounting information, impact on the ASN network is reduced and the performance of the network is maintained.

### BRIEF DESCRIPTION OF THE DRAWINGS

FIG. 1 is a schematic structure diagram of a WiMAX network in the prior art;

FIG. 2 is a schematic structure diagram of a WiMAX network for a method for accounting an MBS service according to an embodiment of the present disclosure;

FIG. 3 is a schematic structure diagram of a WiMAX network for a method for accounting an MBS service according to an embodiment of the present disclosure;

FIG. 4 is a flow chart of a method for accounting an MBS service according to an embodiment of the present disclosure;

FIG. 5 is a flow chart of a method for accounting an MBS service according to another embodiment of the present disclosure;

FIG. 6 is a flow chart of a method for accounting an MBS service according to another embodiment of the present disclosure;

FIG. 7 is a flow chart of a method for accounting an MBS service according to another embodiment of the present disclosure;

FIG. 8 is a flow chart of a method for accounting an MBS service according to another embodiment of the present disclosure;

FIG. 9 is a schematic diagram illustrating an apparatus for accounting an MBS service according to an embodiment of the present disclosure;

FIG. 10 is a schematic diagram illustrating an apparatus for accounting an MBS service according to another embodiment of the present disclosure; and

FIG. 11 is a schematic diagram illustrating an apparatus for accounting an MBS service according to another embodiment of the present disclosure.

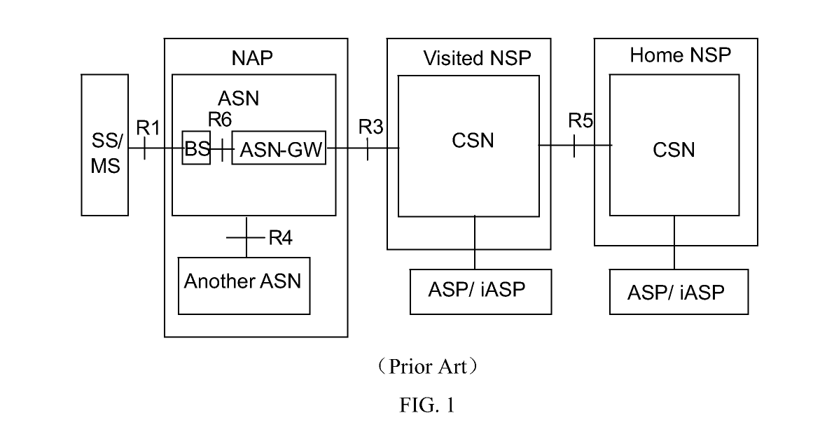

### DETAILED DESCRIPTION OF THE EMBODIMENTS

An embodiment of the present disclosure provides a method for accounting a multicast broadcast service to account an MBS service in a WiMAX network.

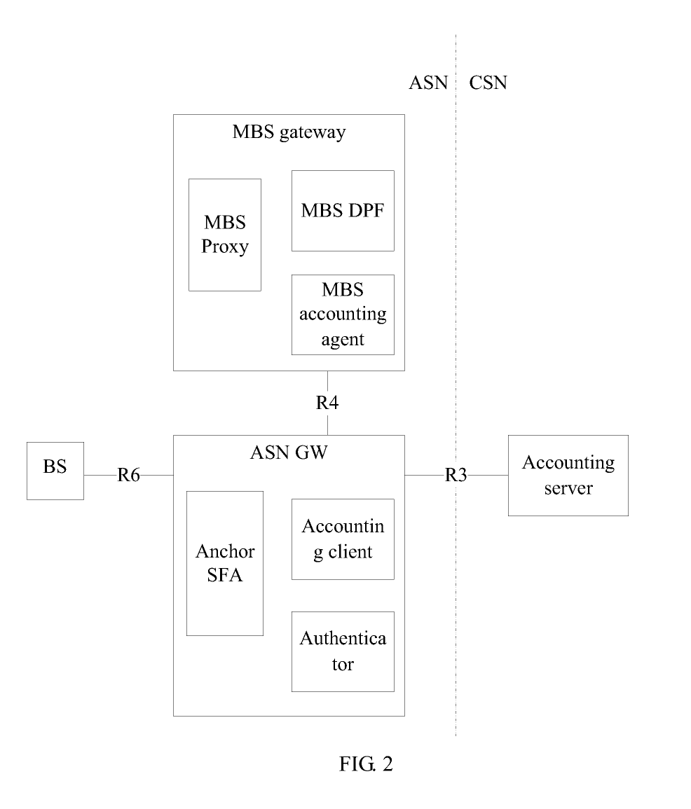

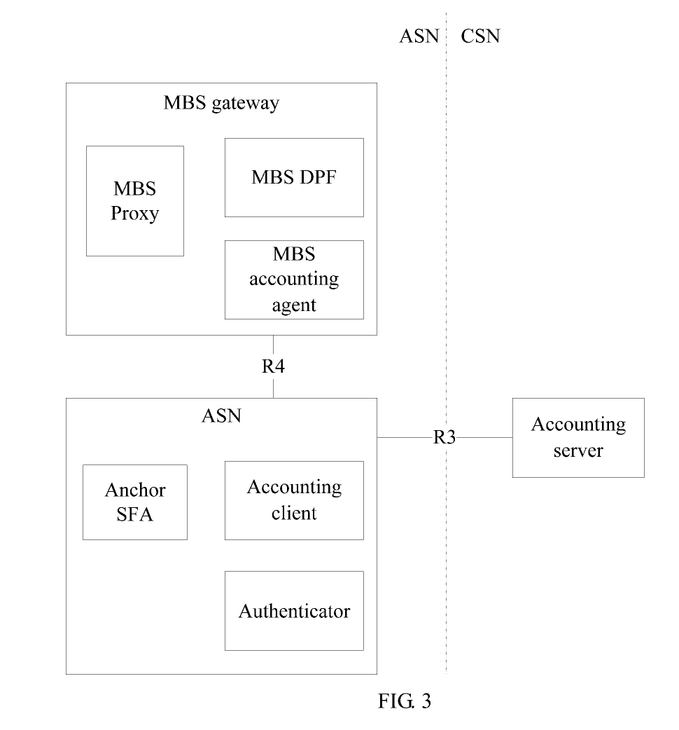

According to an embodiment of the present disclosure, in an existing WiMAX network, an MBS gateway is provided in an ASN, where the MBS gateway includes an MBS Proxy, an MBS Datapath Function (MBS DPF), and an MBS accounting agent. The existing WiMAX network has two network configurations. If the ASN is configured according to Profile A or C, as shown in FIG. 2, the ASN includes a BS and an ASN GW which includes an Anchor SFA, an accounting client and an authenticator, and an MBS gateway is connected with the ASN GW by means of an R4 interface. If the ASN is configured according to Profile B, as shown in FIG. 3, a BS and an ASN GW are not separated from each other in the ASN, and the ASN includes an Anchor SFA, an accounting client, and an authenticator, and an MBS gateway is connected with the ASN by means of an R4 interface.

The MBS DPF, as an MBS datapath function, is an ASN data entry when a CSN provides an MBS service to the ASN.

The MBS Proxy, as an MBS proxy server, which provides an MBS service signaling plane function, is in charge of MSB service signaling processing and forwarding between the MBS server, MS and ASN, and is located on the same network element as the MBS DPF.

The MBS accounting agent is in charge of collecting accounting information about the MBS service, and is located on the same network element as the MBS DPF.

An accounting server in the CSN may either be an independent network element, or be located on an AAA server, and is connected with the ASN or the ASN GW by means of an R3 interface.

The method for accounting a multicast broadcast service according to the embodiment of the present disclosure can be described as follows. The ASN receives MBS service accounting information sent by the MBS accounting agent, where the accounting information includes an MBS service identifier and MBS service granularity-based accounting information. Subscriber service granularity-based accounting information is generated according to MS context information maintained locally and the received MBS service identifier and MBS service granularity-based accounting information. The generated accounting information is sent to an accounting system.

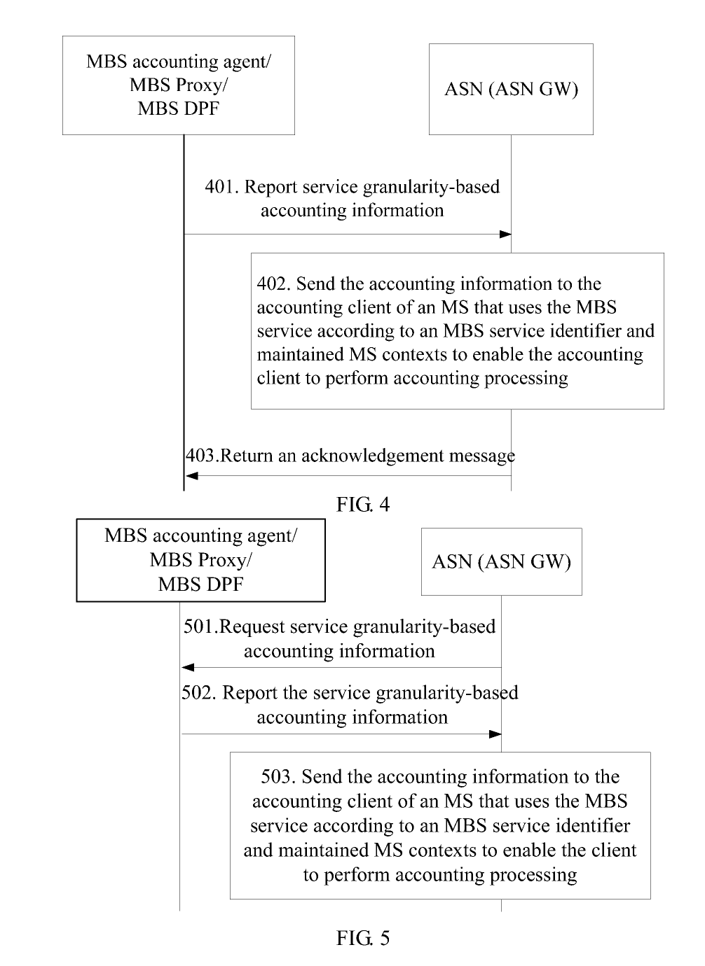

A first embodiment of the present disclosure provides a method for accounting an MBS service, as shown in FIG. 4. The method includes the following steps.

Step 401: An MBS accounting agent collects MBS service accounting information based on service granularity and sends the accounting information to an ASN where an accounting client of the MBS service is located.

The accounting information includes an MBS service identifier and MBS service granularity-based accounting information. The MBS service identifier may be at least one of a service ID, a service name, a service type, a multicast IP address, an MBS zone ID, and a multicast connection ID (MCID), and the MBS service identifier is used to identify the service in a specific zone. The service granularity-based accounting information may be transmitted traffic of the MBS service or duration of the MBS service.

The ASN where the accounting client of the MBS service is located refers to all ASNs in a current MBS zone, or all ASNs that provide the accounting client function in the MBS zone, or ASNs where accounting clients of all MSs accepting the MBS service are located in the MBS zone.

The MBS accounting agent may periodically collect the MBS service accounting information and periodically send the accounting information to the ASN where the accounting client of the MBS service is located. In the case of Profile B, the MBS accounting agent sends the collected accounting information to the ASN GW. In the present application, the MBS accounting agent sends the accounting information to the ASN or the ASN GW, which is called as sending the accounting information to the ASN uniformly. The service granularity-based accounting information may be traffic of the MBS service or duration of the MBS service transmitted in the current period.

Step 402: The ASN determines an MS using the MBS service according to the MBS service identifier, generates subscriber service granularity-based accounting information of the MS, and sends the generated accounting information to an accounting system.

The ASN may search for an MS currently using the MBS service according to MS context information maintained locally, add the MS identifier to the received accounting information, generate subscriber service granularity-based accounting information of the MS and send the accounting information to the accounting system.

The authenticator in the ASN (or ASN GW) searches MS contexts maintained locally according to the MBS service identifier. If a context indicates that there is an MS that uses the MBS service, the accounting client of the MS is triggered to perform accounting processing. Specifically, the accounting client of the MS adds MS identifier information to the service granularity-based accounting information from the MBS accounting agent, where the MS identifier information may be at least one of an NAI of the MS, an MAC address of the MS, an IP address of the MS or a service subscription subscriber identifier, generates the subscriber service granularity-based accounting information, and sends the accounting information generated according to an accounting policy to the accounting system.

In the above step, each MS using the MBS service may be found, and the accounting client of each MS adds identifier information of each MS to the respective MBS service granularity-based accounting information, generates the subscriber service granularity-based accounting information of each MS, and sends the generated accounting information to the accounting system.

The accounting system may charge a subscriber who uses the MBS service according to the received subscriber service granularity-based accounting information. The accounting process is known in the prior art and thus is not described in detail herein.

Step 403: The ASN returns an acknowledgement message to the MBS accounting agent to notify the MBS accounting agent that the accounting information previously sent has been received.

Step 403 is optional and may be executed immediately after the accounting information is received. That is, step 402 and step 403 may be performed concurrently without a strict execution order.

A method for accounting an MBS service according to a second embodiment of the present disclosure differs from a method according to the first embodiment of the present disclosure in that an MBS accounting agent does not send accounting information to an ASN initiatively, but reports collected accounting information to the ASN after receiving an accounting request sent by the ASN. As shown in FIG. 5, the method includes the following steps.

Step 501: The ASN sends an accounting request message to the MBS accounting agent.

The accounting request message may carry an MBS service identifier, which may be at least one of a service ID, a service name, a service type, a multicast IP address, an MBS zone ID, and an MCID, and the MBS service identifier is used to identify a service in a specific Zone. The ASN may send an accounting request message to the MBS accounting agent periodically.

Step 502: The MBS accounting agent collects service granularity-based MBS service accounting information and sends the accounting information to the ASN where an accounting client of the MBS service is located.

The accounting information includes an MBS service identifier and the MBS service granularity-based accounting information, which may be transmitted traffic of the MBS service or duration of the MBS service.

Step 503: The ASN search for an MS currently using the MBS service according to MS context information maintained locally, generates the subscriber service granularity-based accounting information of the MS, and sends the generated accounting information to an accounting system.

Step 503 is similar to step 402, and is not described in detail herein. Further, the ASN may return an acknowledgment message to the MBS accounting agent.

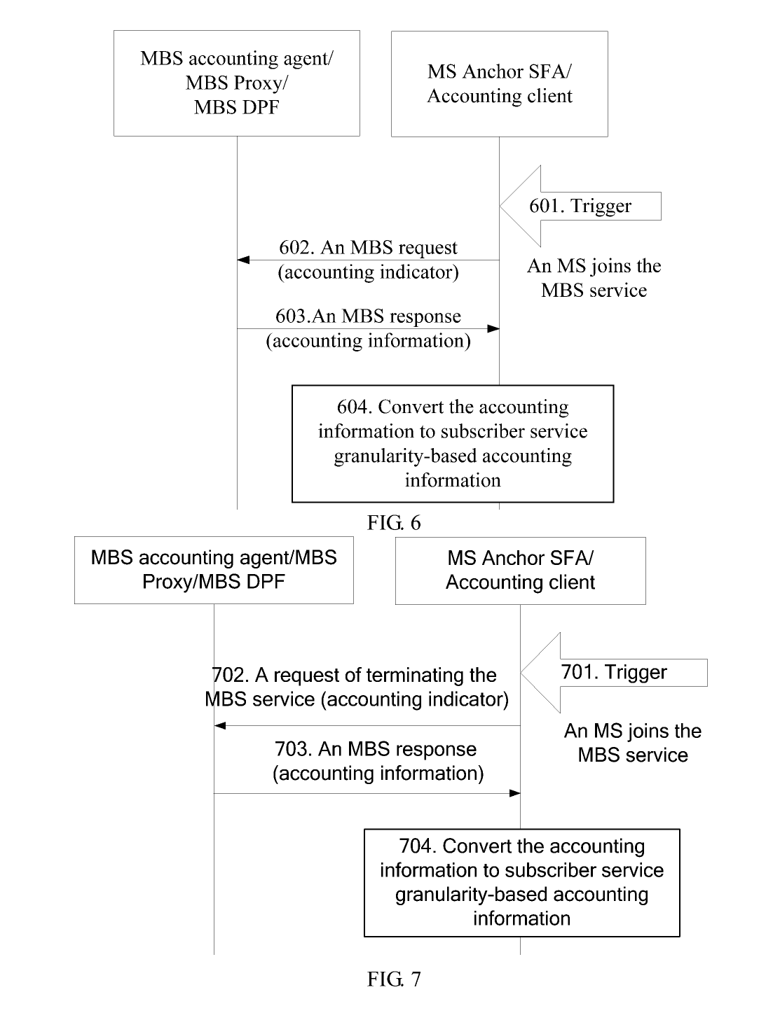

According to a third embodiment, in the process of an MBS accounting agent reporting accounting information periodically, that is, during implementation of the methods according to the first and second embodiments, if an MS joins the MBS service, the MBS accounting agent needs to report the accounting information of the MS to an accounting client of the MS. As shown in FIG. 6, the method includes the following steps.

Step 601: An Anchor SFA of the MS detects occurrence of a trigger event of providing the MBS service to the MS, for example, that the AAA server triggers the Anchor SFA to provide the MBS service to a subscriber according to subscription information of the subscriber, or the subscriber initiates an IGMP join process. An Anchor DPF notifies the Anchor SFA after detecting the IGMP join message and the Anchor SFA provides the corresponding MBS service to the subscriber after the service is authorized.

Step 602: The Anchor SFA sends an MBS request to an MBS Proxy. In the prior art, the request is used to acquire access network parameters of the MBS service, such as an MCID and a logical CID (LCID). According to this embodiment, an accounting indicator may be carried in the request message to require providing the accounting information. According to another embodiment, the MBS request may not carry the accounting indicator, but the accounting agent also reports the accounting information after receiving the MBS request.

Step 603: The MBS accounting agent located on the same network element as the MBS Proxy collects accounting information of the current MBS service based on service granularity, and sends the accounting information to the accounting client of the MS. The accounting information is MBS service granularity-based accounting information and may further include an MBS service identifier. The current MBS service granularity-based accounting information may be information such as transmitted traffic of the MBS service in the period, or duration of the MBS service, etc. The accounting client and the Anchor SFA of the MS are located on the same network element (ASN or ASN GW). The MBS Proxy and the MBS accounting agent are located on the same network element. The communication between the MBS Proxy and the MBS accounting agent is known in the prior art and is not described in detail herein.

Step 604: The accounting client of the MS converts the received accounting information to subscriber service granularity-based accounting information of the MS. Specifically, the accounting client of the MS adds an identifier of the MS to the MBS service granularity-based accounting information, generates subscriber service granularity-based accounting information of the MS, and sends the generated accounting information to an accounting system.

During the next subsequent periodic accounting process, the accounting system further receives the MBS service traffic or duration used by the MS in the accounting period obtained according to first or second embodiments and the accounting system substrates the obtained MBS service traffic or duration which has been transmitted in the period when the MS joins the MBS service from the MBS service traffic or duration in this period, so as to obtain the MBS service traffic or duration actually received by the MS in the period.

According to a fourth embodiment, in the process of an MBS accounting agent reporting accounting information, that is, during implementation of a method according to the first or third embodiments, the MBS accounting agent needs to report the accounting information of an MS to an accounting client of the MS if the MS exits the MBS service. As shown in FIG. 7, the method according to this embodiment includes the following steps.

Step 701: An Anchor SFA of the MS detects occurrence of a trigger event of terminating the MBS service of the MS, for example, a trigger event that an AAA server instructs the Anchor SFA no longer to provide the MBS service to the MS according to subscription information of the subscriber, or the subscriber initiates an IGMP leave process, and an Anchor DPF notifies the Anchor SFA after detecting the IGMP leave message, and the Anchor SFA cancels the corresponding MBS service for the subscriber after completing authorization; or the MS initiates a Dynamic Service Deleting (DSD) process, and the Anchor SFA cancels the corresponding MBS service for the subscriber after completing authorization.

Step 702: The Anchor SFA of the MS sends a request message of terminating the MBS service to an MBS Proxy. The request is used to require terminating the MBS service. According to this embodiment of the present disclosure, an accounting indicator may be added to the request for requiring the accounting information of the MBS service, which is similar to step 602.

Step 703: The MBS accounting agent located on the same network element as the MBS Proxy collects current MBS service accounting information based on service granularity, and provides the accounting information to the accounting client of the MS. The accounting information includes the MBS service granularity-based accounting information and may further include an MBS service identifier. The current MBS service granularity-based accounting information may be information such as traffic or duration of the MBS service which has been transmitted in the period. The accounting client and the Anchor SFA of the MS are located on the same network element (ASN or ASN GW).

Step 704: The accounting client of the MS converts the accounting information to subscriber service granularity-based accounting information of the MS. Specifically, the accounting client of the MS adds the MS identifier to the MBS service granularity-based accounting information, generates the accounting information based on the subscriber service granularity of the MS, and sends the generated accounting information to the accounting system, so that the accounting system charges the subscriber who exits the MBS service.

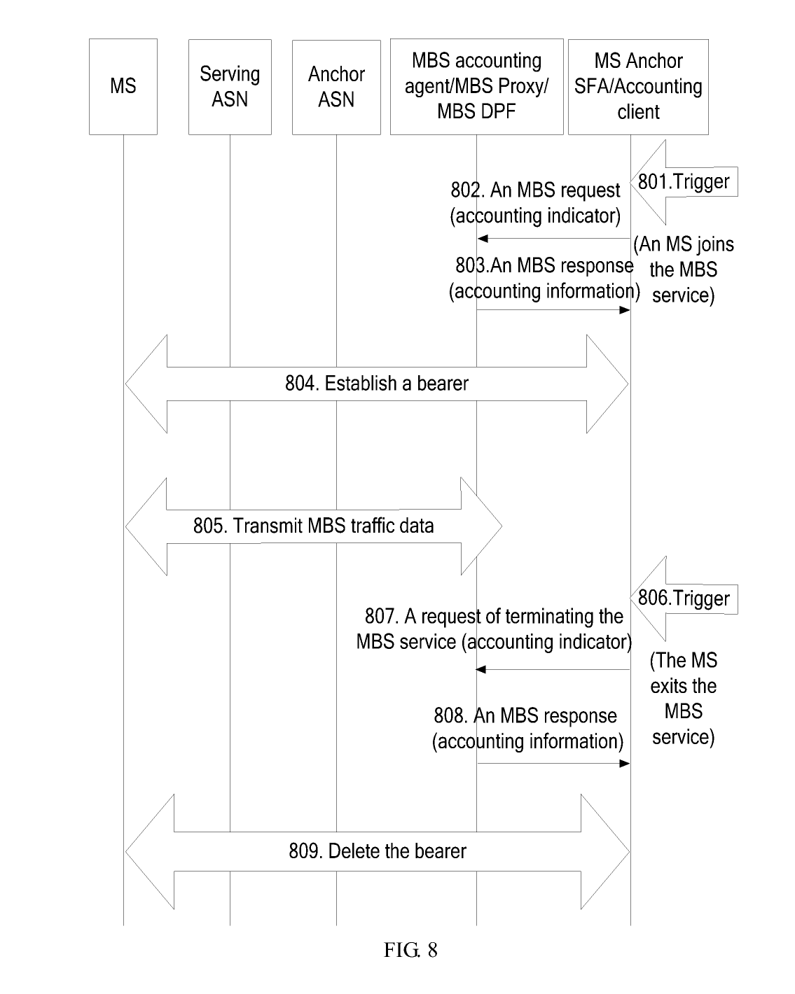

According to a fifth embodiment, an MBS accounting agent does not report accounting information periodically, but reports currently transmitted amount of traffic to an ASN (ASN GW) only when an MS joins or exits the MBS service. An accounting client of the MS or an accounting system obtains the amount of traffic actually used by the MS according to a difference between traffic when the MS joins the MBS service and traffic when the MS exits the service. As shown in FIG. 8, a method according to this embodiment includes the following steps.

Step 801: An Anchor SFA of the MS detects occurrence of a trigger event of providing MBS service to the MS, for example, that the AAA server triggers the Anchor SFA to provide the MBS service to a subscriber according to subscription information of the subscriber, or the subscriber initiates an IGMP join process, the Anchor DPF notifies the Anchor SFA after detecting the IGMP join message, and the Anchor SFA provides the corresponding MBS service to the subscriber after the service is authorized.

Step 802: The Anchor SFA sends an MBS request to an MBS Proxy. In the prior art, the request is used to acquire access network parameters of the MBS, such as an MCID and an LCID. According to this embodiment, an accounting indicator may be added to the request message to require providing the accounting information.

Step 803: The MBS accounting agent located on the same network element as the MBS Proxy collects current MBS service granularity-based accounting information, for example, information such as traffic or duration of the MBS service which has been transmitted, where the traffic or duration of the MBS service which has been transmitted may be the MBS traffic or duration which has been transmitted so far since the beginning of the MBS service; and provides the collected accounting information to the accounting client located on the same network element (ASN or ASN GW) as the Anchor SFA of the MS. The accounting client of the MS converts the received accounting information to subscriber service granularity-based accounting information of the MS. Specifically, the accounting client of the MS adds the MS identifier to the MBS service granularity-based accounting information, generates the subscriber service granularity-based accounting information of the MS, and sends the generated accounting information to the accounting system.

Step 804: The Anchor SFA initiates a bearer establishment process for the MBS service for the MS. This step is known in the prior art and is not described in detail herein.

Step 805: The MS receives MBS service data.

Step 806: The Anchor SFA of the MS detects occurrence of a trigger event of terminating the MBS service, for example, that the AAA server instructs the Anchor SFA no longer to provide the MBS service to a subscriber according to subscription information of the subscriber, or the subscriber initiates an IGMP leave process, the Anchor DPF notifies the Anchor SFA after detecting the IGMP leave message, and the Anchor SFA cancels the corresponding MBS service for the subscriber after completing authorization. Alternatively, the MS initiates a DSD process, and the Anchor SFA cancels the corresponding MBS service for the subscriber after completing authorization.

Step 807: The Anchor SFA of the MS sends a request message of terminating the MBS service to the MBS Proxy to require terminating the MBS service. According to the present disclosure, an accounting indicator may be added to the request for requiring the accounting information of the MBS service.

Step 808: The MBS accounting agent located together with the MBS Proxy reports the collected service granularity-based accounting information to the accounting client of the MS located together with the Anchor SFA of the MS. The accounting information may be information such as traffic or duration of the MBS service which has been transmitted currently and may be the MBS traffic or duration which has been transmitted so far since the beginning of the MBS service. The accounting client of the MS performs accounting processing to the received accounting information. Further, the accounting client of the MS adds the MS identifier to the service granularity-based accounting information, generates subscriber service granularity-based accounting information for the MS, and sends the generated accounting information to the accounting system.

After the accounting system receives the accounting information, according to the MS subscriber service granularity-based accounting information obtained when the MS joins the MSB service and the received accounting information of the MS subscriber service granularity-based accounting information when the MS exits the MSB service, a subtraction operation is performed using the two service traffics or durations to obtain the service traffic or duration actually used by the MS. The accounting system can account the MS according to the service traffic or duration actually used by the MS.

Step 809: A process of deleting the bearer is performed, which is known in the prior art, and is not described in detail herein.

According to another embodiment, in step 803, the accounting information is not sent to the accounting system. In step 808, the service traffic obtained in step 803 is subtracted from the currently obtained service traffic by the accounting client, so as to obtain the amount of the MBS service traffic used by the MS; or the MBS service duration used by the MS can be obtained by subtracting the duration obtained in step 803 from the current duration, and then the service granularity-based accounting information of the MS is generated according to the obtained service traffic or duration actually used by the MS and reported to the accounting system so that the accounting system performs accounting.

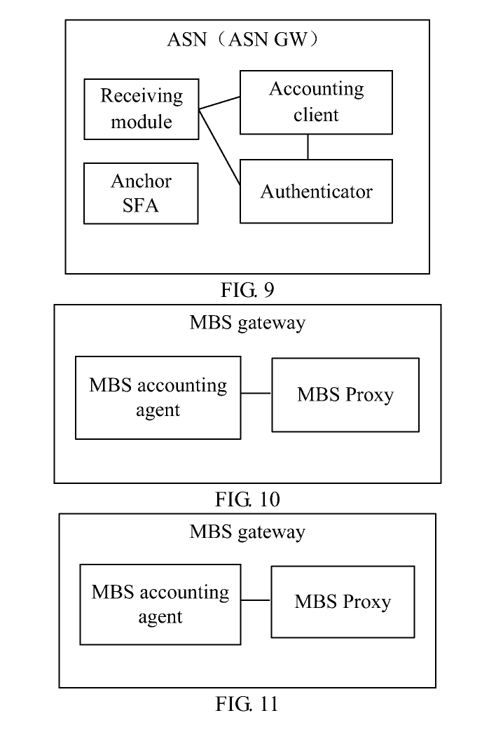

According to a method provided in the first or second embodiments, an apparatus for accounting a multicast broadcast service is further disclosed, which is described with reference to FIG. 9. A receiving module is configured to receive an MBS service identifier and MBS service granularity-based accounting information sent by an MBS accounting agent. An authenticator is configured to search for MS contexts maintained locally according to the MBS service identifier, and finding MSs currently using the MBS service. An accounting client is configured to add identifier information of each MS to the respective MBS service granularity-based accounting information, to generate subscriber service granularity-based accounting information of each MS, and to send the generated accounting information to an accounting system.

According to a method provided in the third or fourth embodiments, the apparatus may further include an Anchor SFA, which is configured to send an MBS request to an MBS Proxy upon detecting occurrence of a trigger event of providing an MBS service to an MS and to send a request for terminating the MBS service to the MBS Proxy upon detecting occurrence of a trigger event of terminating the MBS service for the MS.

The above apparatus may be an ASN or an ASN GW.

Corresponding to the first or second embodiments, an MBS accounting agent is further disclosed. Referring to FIG. 10, a collecting module is configured to collect current MBS service accounting information based on service granularity, where the accounting information includes an MBS service identifier and MBS service granularity-based accounting information. A sending module is configured to send the MBS service accounting information to an ASN.

Corresponding to the third or fourth embodiments, an MBS gateway is further disclosed. As shown in FIG. 11, the MBS gateway includes the above MBS accounting agent, and further includes an MBS Proxy, which is configured to receive an MBS request or a request for terminating an MBS service sent by an Anchor SFA, to trigger an MBS accounting agent to collect MBS accounting information based on service granularity, and to send the collected accounting information to an ASN.

According to the fifth embodiment, an apparatus for accounting a multicast broadcast service is further disclosed. This apparatus includes an Anchor SFA, which is configured to detect occurrence of a trigger event of providing an MBS service to an MS and to send an MBS request to an MBS Proxy. An accounting client is configured to receive first current MBS service granularity-based accounting information collected by an MBS accounting agent located together with the MBS Proxy. The Anchor SFA is further configured to detect occurrence of a trigger event that the MS exits the MBS service and to send a request for terminating the MBS service to the MBS Proxy. The accounting client is further configured to receive second current MBS service granularity-based accounting information collected by the MBS accounting agent located together with the MBS Proxy. The accounting client is further configured to generate subscriber service granularity-based accounting information actually used by the MS according to the first current MBS service granularity-based accounting information and the second current MBS service granularity-based accounting information and to report the generated accounting information to an accounting system.

The above apparatus may be an ASN or an ASN GW.

An embodiment of the present disclosure further discloses an apparatus for accounting a multicast broadcast service. The apparatus includes an Anchor SFA that is configured to detect occurrence of a trigger event of providing an MBS service to an MS and to send an MBS request to an MBS Proxy. An accounting client is configured to receive first current MBS service granularity-based accounting information collected by an MBS accounting agent located together with the MBS Proxy, to generate subscriber service granularity-based accounting information, and to report the generated accounting information to an accounting system. The Anchor SFA is further configured to detect occurrence of a trigger event that the MS exits the MBS service and to send a request for terminating the MBS service to the MBS Proxy. The accounting client is further configured to receive second current MBS service granularity-based accounting information collected by the MBS accounting agent located together with the MBS Proxy, to generate subscriber service granularity-based accounting information, and to report the generated accounting information to the accounting system.

The above apparatus may be an ASN or an ASN GW.

With the accounting method and the apparatus provided by the embodiments of the present disclosure, the MBS accounting agent collects accounting information based on service granularity and reports the MBS service granularity-based accounting information to the accounting client so that the accounting client can perform accounting processing to all MSs using the MBS service under the control of the ASN GW or the ASN. The accounting agent does not need to collect and report the same accounting information repeatedly with respect to each MS using the MBS service, thereby saving a large amount of intra-ASN signaling resources. In addition, when an MS joins the MBS service, or an MS exits the MBS service, charging on subscribers is also performed smoothly.

It is apparent to persons skilled in the art that the process of realizing the frame offset adjusting method in the embodiments of the present disclosure can be implemented by a program instructing related hardware. The program can be stored in a readable storage medium and perform corresponding steps in the above method when being executed. The storage medium stated herein may be a read-only memory (ROM), a random access memory (RAM), a disk, and a compact disc.

The above description is intended to illustrate only preferred embodiments of the present disclosure, and is not intended to limit the present disclosure. Any modifications, equivalent replacements and improvements without departing from the scope and principle of the present disclosure shall fall within the protection scope of the present disclosure.

What is claimed is:

1. A method for accounting a multicast broadcast service (MBS), the method comprising:
detecting, by an Anchor Service Flow Authentication (Anchor SFA) in an Access Service Network (ASN), occurrence of a trigger event of providing an MBS service to a mobile station (MS);
sending an MBS request from the Anchor SFA in the ASN to an MBS Proxy;
receiving, by an accounting client in the ASN, first current MBS service granularity-based accounting information collected by an MBS accounting agent located together with the MBS Proxy;
detecting, by the Anchor SFA in the ASN, occurrence of a trigger event that the MS exits the MBS service;
sending a request for terminating the MBS service from the Anchor SFA in the ASN to the MBS Proxy;
receiving, by the accounting client in the ASN, second current MBS service granularity-based accounting information collected by the MBS accounting agent located together with the MBS Proxy;
generating subscriber service granularity-based accounting information actually used by the MS according to the first current MBS service granularity-based accounting information and the second current MBS service granularity-based accounting information; and
reporting the generated accounting information to an accounting system.

2. A method for accounting a multicast broadcast service (MBS), the method comprising:
receiving, by an Access Service Network (ASN), MBS service accounting information sent by an MBS accounting agent, wherein the MBS service accounting information comprises an MBS service identifier and MBS service granularity-based accounting information;
determining a mobile station (MS) that uses the MBS service according to the MBS service identifier;
generating subscriber service granularity-based accounting information of the MS; and
sending the generated accounting information to an accounting system.

3. The method according to claim 2, before receiving the MBS service accounting information, further comprising:
periodically collecting, by an MBS proxy, MBS service accounting information based on service granularity, and sending the collected MBS service accounting information to the ASN.

4. The method according to claim 2, before receiving the MBS service accounting information, further comprising:
periodically sending, by the ASN, an accounting information request message to the MBS accounting agent;
collecting, by the MBS accounting agent, MBS service accounting information after receiving the accounting information request message; and
sending the collected accounting information to the ASN.

5. The method according to claim 3, wherein the MBS service granularity-based accounting information comprises the transmitted MBS service traffic or MBS service duration in the current period.

6. The method according to claim 4, wherein the MBS service granularity-based accounting information comprises the transmitted MBS service traffic or MBS service duration in the current period.

7. The method according to claim 2, wherein determining the MS that uses the MBS service and generating the subscriber service granularity-based accounting information comprises:
searching for, by an authenticator in the ASN, MS contexts maintained locally according to the MBS service identifier, finding MSs that use the MBS service currently,
triggering the accounting client of each of the MSs to add identifier information of the MS to the MBS service granularity-based accounting information, and
generating subscriber service granularity-based accounting information of each of the MSs.

8. The method according to claim 3, further comprising:
sending, by an Anchor SFA in the ASN, an MBS request or a request for terminating the MBS service to the MBS Proxy after detecting a trigger event for providing the MBS service to an MS or a trigger event for terminating the MBS service for an MS;
collecting, by the MBS accounting agent, the accounting information of the current MBS service based on service granularity;
sending the collected accounting information from the MBS accounting agent to the accounting client of the MS in the ASN;
converting, by the accounting client, received accounting information to the subscriber service granularity-based accounting information of the MS; and
reporting the generated accounting information to the accounting system.

9. The method according to claim 4, further comprising:
sending, by an Anchor SFA in the ASN, an MBS request or a request for terminating the MBS service to the MBS Proxy after detecting a trigger event for providing the MBS service to an MS or a trigger event for terminating the MBS service for an MS;
collecting, by the MBS accounting agent, the accounting information of the current MBS service based on service granularity;
sending the collected accounting information from the MBS accounting agent to the accounting client of the MS in the ASN;
converting, by the accounting client, received accounting information to the subscriber service granularity-based accounting information of the MS; and
reporting the generated accounting information to the accounting system.

10. The method according to claim 8, wherein the MBS request comprises an accounting indicator.

11. The method according to claim 9, wherein the MBS request comprises an accounting indicator.

12. A method for accounting a multicast broadcast service (MBS), the method comprising:
detecting, by an Anchor Service Flow Authentication (Anchor SFA) in an Access Service Network (ASN), occurrence of a trigger event for providing an MBS service to a mobile station (MS);
sending an MBS request from the Anchor SFA in the ASN to an MBS Proxy;
receiving, by an accounting client in the ASN, first current MBS service granularity-based accounting information collected by an MBS accounting agent located together with the MBS Proxy;
converting, by the accounting client in the ASN, the first current MBS service granularity-based accounting information to first subscriber service granularity-based accounting information of the MS;
reporting, by the accounting client in the ASN, the converted accounting information to an accounting system;
detecting, by the Anchor SFA in the ASN, occurrence of a trigger event that the MS exits the MBS service, and sending a request for terminating the MBS service to the MBS Proxy; and
receiving, by the accounting client in the ASN, second current MBS service granularity-based accounting information collected by the MBS accounting agent located together with the MBS Proxy;
converting, by the accounting client in the ASN, the second current MBS service granularity-based accounting information into second subscriber service granularity-based accounting information of the MS; and
reporting, by the accounting client in the ASN, the converted accounting information to the accounting system.

13. An apparatus for accounting a multicast broadcast service (MBS), the apparatus comprising:
an Anchor Service Flow Authentication (Anchor SFA), configured to detect occurrence of a trigger event for providing an MBS service to a mobile station (MS) and to send an MBS request to an MBS Proxy; and
an accounting client, configured to receive first current MBS service granularity-based accounting information collected by an MBS accounting agent located together with the MBS Proxy;
wherein the Anchor SFA is further configured to detect occurrence of a trigger event that the MS exits the MBS service and to send a request for terminating the MBS service to the MBS Proxy;
wherein the accounting client is further configured to receive second current MBS service granularity-based accounting information collected by the MBS accounting agent located together with the MBS Proxy; and
wherein the accounting client is further configured to generate subscriber service granularity-based accounting information actually used by the MS according to the first current MBS service granularity-based accounting information and the second current MBS service granularity-based accounting information, and to report the generated accounting information to an accounting system.

14. An apparatus for accounting a multicast broadcast service (MBS), the apparatus comprising:
a receiving module, configured to receive an MBS service identifier and MBS service granularity-based accounting information sent by an MBS accounting agent;
an authenticator, configured to search for mobile station (MS) contexts maintained locally according to the MBS service identifier, and to find MSs that use the MBS service currently; and
an accounting client, configured to add the identification information of each of the MSs to the respective MBS service granularity-based accounting information, to generate subscriber service granularity-based accounting information of each of the MSs, and to send the generated accounting information to an accounting system.

15. The apparatus according to claim 14, further comprising:
an Anchor Service Flow Authentication (Anchor SFA), configured to detect occurrence of a trigger event of providing an MBS service to an MS, and to send an MBS request to an MBS Proxy.

16. The apparatus according to claim 14, further comprising:
an Anchor Service Flow Authentication (Anchor SFA), configured to detect occurrence of a trigger event of terminating the MBS service for the MS, and to send a request for terminating the MBS service to the MBS Proxy.

17. An apparatus for accounting a multicast broadcast service (MBS), the apparatus comprising:
an Anchor Service Flow Authentication (Anchor SFA), configured to detect occurrence of a trigger event of providing an MBS service to an MS, and to send an MBS request to an MBS Proxy; and
an accounting client, configured to receive first current MBS service granularity-based accounting information collected by an MBS accounting agent located together with the MBS Proxy, to generate subscriber service granularity-based accounting information, and to report the generated accounting information to an accounting system;
wherein the Anchor SFA is further configured to detect occurrence of a trigger event that the MS exits the MBS service, and to send a request for terminating the MBS service to the MBS Proxy; and
wherein the accounting client is further configured to receive second current MBS service granularity-based accounting information collected by the MBS accounting agent located together with the MBS Proxy, to generate subscriber service granularity-based accounting information, and to report the generated accounting information to the accounting system.
